(19) United States
(12) Patent Application Publication
(10) Pub. No.: US 2023/0235553 A1
(43) Pub. Date: Jul. 27, 2023

(54) SOUND CONTROL COMPONENTS COMPRISING FOAM COMPOSITES

(71) Applicants: Hamed LAKROUT, San Antonio, TX (US); Russell L. HILL, San Antonio, TX (US); Robert F. RATHBONE, San Antonio, TX (US); BORAL IP HOLDINGS (AUSTRALIA) PTY LIMITED, North Sydney NSW (AU)

(72) Inventors: Hamed LAKROUT, San Antonio, TX (US); Russell L. HILL, San Antonio, TX (US); Robert F. RATHBONE, San Antonio, TX (US)

(73) Assignee: WESTLAKE ROYAL BUILDING PRODUCTS INC., Houston, TX (US)

(21) Appl. No.: 18/001,312

(22) PCT Filed: Jun. 9, 2021
(86) PCT No.: PCT/US2021/036516

§ 371 Date: Dec. 9, 2022

Related U.S. Application Data
(60) Provisional application No. 63/037,037, filed on Jun. 10, 2020.

(51) Int. Cl. E04B 1/86; G10K 11/165

(52) U.S. Cl. CPC E04B 1/86; G10K 11/165; E04B 2001/8263

(57) ABSTRACT

Panel systems and related methods of controlling sound transmission are discussed. For example, the panel system may include a sound control component, which may include a foam composite of a polymer and an inorganic filler. The panel system may further include an attachment mechanism, e.g., including at least one fastener, at least one bracket, and/or at least one rail or rail system. The attachment mechanism may be configured to secure the sound control component between a first wall and a second wall, such that the panel system controls sound transmission between the first and second walls.

### CROSS-REFERENCE TO RELATED APPLICATION

The application claims priority to U.S. Provisional Application No. 63/037,037, filed Jun. 10, 2020, which is incorporated herein by reference in its entirety.

### TECHNICAL FIELD

The present disclosure generally relates to sound control components comprising a foam composite. The sound control components may be used to attenuate sound, such as through an intertenancy wall.

### BACKGROUND

Noise can be problematic in multi-occupant structures, including residential complexes and commercial buildings. Many materials used in construction provide insufficient dampening of sound between rooms, such that sound generated in one room propagates through adjacent rooms. Sound transmission across a medium can occur through a variety of mechanisms. For instance, sound can transfer via airborne paths as well as through structural elements. While certain structural elements have been developed to mitigate sound transmission, the materials are often bulky, heavy, and expensive.

### SUMMARY

The present disclosure includes panel systems for sound control and methods of preparation and use thereof. For example, the panel system may be configured for controlling sound transmission between a first wall and a second wall, wherein the panel system comprises a sound control component comprising a foam composite comprising a polymer and an inorganic filler, wherein the inorganic filler is present in an amount of 40% to 80% by weight, based on the total weight of foam composite; wherein the foam composite has a density of 3 pcf to 30 pcf; and wherein the foam composite has (i) a porosity of 30% to 95% and/or (ii) an open cell percentage of 5% to 95%. The panel system may include an attachment mechanism configured to secure the sound control component between the first wall and the second wall. For example, the attachment mechanism may comprise at least one of a tongue, a groove, a fastener, a bracket, or a rail. The first wall and/or the second wall may comprise drywall, a fiber, a polymer, or metal, for example.

According to some aspects of the present disclosure, the foam composite has a thickness less than or equal to 75 mm, such as less than or equal to 50 mm. Additionally or alternatively, the foam composite may comprise a fire retardant, a fiber material, or a mixture thereof. The polymer of the foam composite may comprise polyurethane, for example. Additionally or alternatively, the inorganic filler may comprise fly ash, limestone, clay, gypsum, or glass powder.

The sound control component may include one or more facing materials covering a surface of the foam composite. In some examples, the facing material(s) may comprise a viscoelastic material. The thickness of the facing material(s) may be a thickness of the facing material is less than or equal to 25 mm. According to some aspects, the foam composite has a noise reduction coefficient of 0.5 or greater, e.g., 0.65 or greater, at frequencies of 1 kHz or higher, such as 2 kHz or higher.

The present disclosure also includes a method of controlling sound transmission between a first wall and a second wall, the method comprising providing a panel system comprising a sound control component between the first wall and the second wall, wherein the sound control component comprises a foam composite comprising a polymer and an inorganic filler, wherein the inorganic filler is present in an amount of 40% to 80% by weight, based on the total weight of foam composite; wherein the foam composite has a density of 3 pcf to 30 pcf, a porosity of 30% to 95%, e.g., 50% to 95%, and/or an open cell percentage of 5% to 95%; and wherein the sound control component attenuates transmission of sound therethrough.

The panel system may include any of the features described above and/or elsewhere herein. For example, the panel system may comprise an attachment mechanism comprising at least one of a tongue, groove, fastener, a bracket, or a rail, wherein the attachment mechanism secures the sound control component between the first wall and the second wall. The first wall and/or the second wall may comprise, e.g., drywall, a fiber, a polymer, or metal.

Additionally, the methods herein include controlling sound transmission between a first wall and a second wall, the method comprising: providing a panel system comprising: a sound control component between the first wall and the second wall, wherein the sound control component comprises a foam composite comprising a polymer and an inorganic filler, wherein the inorganic filler is present in an amount of 40% to 80% by weight, based on the total weight of foam composite; and an attachment mechanism securing the sound control component between the first wall and the second wall; wherein the foam composite has a density of 3 pcf to 30 pcf, a porosity of 30% to 95%, e.g., 50% to 95%, and/or an open cell percentage of 5% to 95%; and wherein the sound control component attenuates transmission of sound therethrough. In some examples, the attachment mechanism comprises at least one fastener and at least one bracket. The polymer of the foam composite may comprise polyurethane and/or the inorganic filler may comprise fly ash, limestone, clay, gypsum, or glass powder. According to some aspects, the foam composite has a noise reduction coefficient of 0.5 or greater, such as, e.g., 0.65 or greater, at frequencies of 1 kHz or higher, such as 2 kHz or higher.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIGS. 1A and 1B show exemplary foam composites, as discussed in Example 1.

FIG. 2 is a graph of transmission loss versus sound frequency, as discussed in Example 2.

### DETAILED DESCRIPTION

The singular forms “a,” “an,” and “the” include plural reference unless the context dictates otherwise. The terms “approximately” and “about” refer to being nearly the same as a referenced number or value. As used herein, the terms “approximately” and “about” generally should be understood to encompass ±5% of a specified amount or value. All ranges are understood to include endpoints, e.g., a thickness between 20 mm and 200 mm includes thicknesses of 20 mm, 200 mm, and all values between.

Sound is typically composed of a range of frequencies/wavelengths. Various frequencies of sound interact with materials in a different manner. For instance, porous materials can be used to trap high frequency sound, however lower frequency sound transmits more completely across these materials. Thus, the present disclosure includes materials for reducing higher frequency and lower frequency components for effective sound reduction. The present disclosure includes composite materials and structures that balance porosity with density and/or other characteristics for effective sound control, such materials and structure being useful for intertenancy walls (also referred to as party walls or demising walls). For example, the materials herein may be porous to allow for the capture of sound of varying frequencies (e.g., 20 Hz to 20 kHz). The porous materials may have connectivity and tortuosity properties that provide for absorption of, e.g., high frequency sound, such as frequencies above 500 Hz or above 1 kHz, and/or low frequency sound, such as frequencies less than or equal to 500 Hz. Further, for example, the thickness, mass, and/or density of the materials herein may be selected to control sound transmission, e.g., to attenuate transmission of sound through an intertenancy wall. The sound control components herein may absorb, reduce transmission, reduce propagation, dampen, mitigate, and/or reduce selected frequencies of sound.

The sound control components herein may comprise materials with viscoelastic properties capable of absorbing sound waves to dampen vibration and sound transmission. In some examples, the materials may convert the energy from sound waves into heat and movement. The materials herein include composites configured to provide relatively high porosity to maximize sound control. In some examples, the sound control components herein include a porous substrate (e.g., a foam composite) and an elastomeric material coupled to, e.g., at least partially covering, the surface of the porous substrate. The porous material may effectively trap and dissipate sound within a first frequency range, e.g., in voids present in the body of the porous material, while a viscoelastic facing material on the surface of the porous material may be more effective at damping sound within a second frequency range. For example, the first frequency range may be higher than the second frequency range.

The present disclosure includes materials configured as sound control components and panel systems comprising such sound control components for building structures, and methods of preparation and use thereof. The materials may be tailored for sound reduction across a wide variety of applications. The panel systems herein may comprise a sound control component, and optionally an attachment mechanism coupled to the sound control component, wherein the sound control component may comprise a foam composite. The chemicophysical properties of the composite may be modified through chemistry, microstructure, and/or design on a nanoscale to macroscale for sound attenuation.

Exemplary polymers for the foam composites herein include, but are not limited to, organic polymers and polymer hybrids, including hybrid thermosets. For example, the polymer may comprise polyurethane, a polyurethane-epoxy hybrid, polyurea, polyisocyanurate, a polyisocyanurate-epoxy hybrid, or a combination thereof. In at least one example, the foam composite comprises polyurethane, optionally present as a mixture of polyurethane and polyurea, or as a polyurethane-epoxy hybrid. In at least one example, the foam composite comprises polyisocyanurate, optionally present as a polyisocyanurate-epoxy hybrid. The polymer of the foam composite may comprise a polymer of the type disclosed in U.S. Pat. No. 5,859,082 or U.S. Patent Application Publication No. 2012/0149842, each incorporated by reference herein.

According to some aspects of the present disclosure, the polymer of the foam composite is prepared by combining one or more polyols with an isocyanate to form a mixture suitable for crosslinking. Isocyanates suitable for use in preparing the foam composites herein may include one or more monomeric or oligomeric poly- or di-isocyanates. The monomeric or oligomeric poly- or di-isocyanates include aromatic diisocyanates and polyisocyanates. Exemplary diisocyanates include, but are not limited to, methylene diphenyl diisocyanate (MDI), including MDI monomers, oligomers, and combinations thereof.

The polyols useful for the polymer of the foam composites herein may include compounds of different reactivity, e.g., having different numbers of primary and/or secondary hydroxyl groups. Polyols with lower reactivity generally provide for longer cream times and/or tack-free times. In some embodiments, the one or more polyols may be capped with an alkylene oxide group, such as ethylene oxide, propylene oxide, butylene oxide, and combinations thereof, to provide the polyols with the desired reactivity. The one or more polyols can include a poly(propylene oxide) polyol including terminal secondary hydroxyl groups, the compounds being end-capped with ethylene oxide to provide primary hydroxyl groups.

In some embodiments, the foam composite is prepared from one or more polyols having a primary hydroxyl number less than 220 (as measured in units of mg KOH/g), such as 10 to 220, 50 to 200, or 100 to 150. The number of primary hydroxyl groups can be determined using fluorine NMR spectroscopy as described in ASTM D4273. In some embodiments, the polyol(s) have a hydroxyl number or average hydroxyl number (as measured in units of mg KOH/g) of 1000 or less and/or 50 or more, such as an average hydroxyl number of 100 to 700, 100 to 500, 400 to 500, 300 to 400, or 200 to 400.

Polyols useful for the foam composites herein include, but are not limited to, aromatic polyols, polyester polyols, poly ether polyols, Mannich polyols, and combinations thereof. Exemplary aromatic polyols include, for example, aromatic polyester polyols, aromatic polyether polyols, and combinations thereof. The polyol(s) may comprise at least one amine group, such as one or more primary amine groups, secondary amine groups, tertiary amine groups, or combinations thereof. In some embodiments, the total amine value (a measure of the concentration of primary, secondary, and tertiary amine groups in units of mg KOH/g) is 50 or less, 30 or less, 10 or less, or 5 or less. For example, the polyol(s) may have a total amine value (mg KOH/g) of greater than 0 to 50, 10 to 40, 20 to 30, or 5 to 15. The polyol(s) useful for the present disclosure may have a desired functionality. For example, the functionality of the polyol(s) may be 7.0 or less and/or 2.0 or greater, such as an average functionality of 2.0 to 5.5, 3.0 to 5.0, 2.5 to 4.0, 2.5 to 3.5, or 3.0 to 4.0.

According to some aspects of the present disclosure, the polymer of the foam composite is prepared without an isocyanate. For example, the polymer may be prepared by combining a compound having at least one cyclocarbonate group and a compound comprising at least one epoxy group to form a mixture suitable for crosslinking. In yet other examples, the polymer of the foam composite is prepared by combining a polyisocyanate with at least one polyol and a compound having at least one epoxy group. Exemplary compounds with epoxy groups that may be used in preparing the foam composites herein may include, but are not limited to, phenolic based epoxies, polyepoxide compounds, and thermosettable resins having an average of more than one (e.g., about two or more) epoxy groups per molecule.

The foam composites herein may comprise a filler material, such as, e.g., an inorganic particulate material. For example, the inorganic filler may be added to the mixture prior to foaming the mixture to produce the foam composite. Examples of inorganic fillers useful for the foam composites herein include, but are not limited to, fly ash, amorphous carbon (e.g., carbon black), silica (e.g., silica sand, silica fume, quartz), glass (e.g., ground/recycled glass such as window or bottle glass, milled glass, glass spheres, glass flakes, glass powder), calcium carbonate, calcium oxide, calcium hydroxide, aluminum trihydrate, clay (e.g., kaolin, red mud clay, bentonite), mica, talc, wollastonite, alumina, feldspar, gypsum (calcium sulfate dehydrate), dolomite, limestone, garnet, saponite, beidellite, granite, slag, antimony trioxide, barium sulfate, magnesium oxide, magnesium hydroxide, aluminum hydroxide, gibbsite, titanium dioxide, zinc carbonate, zinc oxide, molecular sieves, perlite (including expanded perlite), diatomite, vermiculite, pyrophillite, expanded shale, volcanic tuff, pumice, hollow ceramic spheres, hollow plastic spheres, expanded plastic beads (e.g., polystyrene beads), ground tire rubber, and mixtures thereof.

In some embodiments, the inorganic filler may comprise an ash produced by firing fuels including coal, industrial gases, petroleum coke, petroleum products, municipal solid waste, paper sludge, wood, sawdust, refuse derived fuels, switchgrass or other biomass material. For example, the inorganic filler may comprise a coal ash, such as fly ash, bottom ash, or combinations thereof. In some examples herein, the foam composite comprises fly ash selected from Class C fly ash, Class F fly ash, or a mixture thereof. In some embodiments, the inorganic filler consists of or consists essentially of fly ash.

The inorganic filler can be present in the composite material in an amount of 40% to 90% by weight, such as 45% to 75% by weight, 50% to 80% by weight, 40% to 60% by weight, or 60% to 80% by weight, based on the total weight of the foam composite. For example, the amount of inorganic filler may be about 40%, about 42%, about 45%, about 48%, about 50%, about 52%, about 55%, about 58%, about 60%, about 62%, about 65%, about 68%, about 70%, about 72%, about 75%, about 78%, about 80%, about 82%, about 85%, about 88%, or about 90% by weight.

In some examples, the foam composite comprises one or more fiber materials, which may include any natural and/or synthetic fibers. The fibers may be relatively thin and/or flexible. Incorporating fibers in the foam composite may improve the sound absorption properties of the open cell foam composite structures herein. Exemplary fiber materials include, but are not limited to, glass fibers, silica fibers, carbon fibers, metal fibers, mineral fibers, microwool, organic polymer fibers, cellulose fibers, biomass fibers, and combinations thereof. The fibers may be at least partially dispersed within the foam composite. In some examples, the fibers are present as individual fibers, chopped fibers, bundles, strings such as yarns, fabrics, papers, rovings, mats, or tows. According to some aspects of the present disclosure, the foam composite comprises a plurality of fibers having an average length of 5 mm to 20 mm, e.g., 5 mm to 15 mm, or 5 mm to 10 mm. Additionally or alternatively, the foam composite may include fibers having an average length less than 5 mm, such as less than 1 mm, or less than 500 μm. In some embodiments, the foam composite does not include any fibers.

The foam composites herein may comprise one or more additional materials, such as, e.g., foaming agents, surfactants, chain-extenders, crosslinkers, coupling agents, UV stabilizers, fire retardants, antimicrobials, anti-oxidants, cell openers, and/or pigments. Exemplary surfactants include, but are not limited to, silicone surfactants, such as a poly-siloxane-polyether copolymer. Exemplary fire retardants include, but are not limited to, organohalogen compounds and/or organophosphorus compounds, such as tris(chloropropyl)phosphate (TCCP), and other phosphate compounds such as ammonium polyphosphate. In some embodiments, the foam composite is rated a semi-combustible according to ISO 5660 21:2015—Reaction-to-fire tests—Heat release, smoke production and mass loss rate—Part 1: Heat release rate (cone calorimeter method) and smoke production rate (dynamic measurement). The foam composite may meet the standards of Class A, Class B, or Class C of ASTM E-84. In some examples, the foam composite has a fire rating of 1 hour to 1.5 hours as measured according to ASTM E119-18ce1—Standard Test Methods for Fire Tests of Building Construction and Materials.

The composite materials herein may be prepared with a catalyst, e.g., to facilitate curing and control curing times. Examples of suitable catalysts include, but are not limited to catalysts that comprise amine groups (including, e.g., tertiary amines such as 1,4-diazabicyclo[2.2.2]octane (DABCO), tetramethylbutanediamine, and diethanolamine) and catalysts that contain tin, mercury, or bismuth.

The foam composites herein may be prepared using chemical blowing agents, physical blowing agents, or a combination thereof. The foam composites herein may be prepared by free rise foaming or by extrusion. In the case of free rise foaming, the mixture is typically added to a mold and set aside to allow the mixture to foam. The resulting foam composite can then be cut into a desired shape and/or size, such as sheets or large blocks generally referred to as buns or foam buns. In some embodiments, the foaming may be in a mold or in situ. For instance, the foaming may occur adjacent to a mold surface or a building surface, such that a portion of the foam cell structure contacting such surface compresses or collapses. A portion of the foam cell structure compressed or collapsed may form a skin structure. In the case of extrusion, the mixture may be passed through a vessel of a continuous conveyer system, wherein the mixture foams and is shaped through contact with the walls of the vessel. In both cases, formation of the foam composite can be characterized in terms of the cream time, referring to the time at which the mixture starts to foam or expand, and the tack free time, referring to the period from the start of cure/foaming to a point when the material is sufficiently robust to resist damage by touch or settling dirt. In some examples, a combined cream time and tack-free time of the mixture used to prepare the foam composite is 5 seconds to 1 hour. For example, the cream time of the mixture may be 5 seconds to 3 minutes, and the tack-free time of the mixture may be 20 seconds to 25 minutes.

According to some aspects of the present disclosure, the foam composite may have a thickness of 5 mm to 75 mm, such as 10 mm to 65 mm, 15 mm to 50 mm, 20 mm to 45 mm, 35 mm to 55 mm, or 5 mm to 25 mm. The foam composite may be relatively light weight, e.g., providing for sound control components that are lighter and/or less dense that other structural materials like concrete-based panel systems. In some embodiments, the foam composite has an average density greater than or equal to 3 lb/ft³ (pcf) and/or less than or equal to 40 pcf, such as about 3 pcf to about 30 pcf, about 3 pcf to about 15 pcf, about 4 pcf to about 20 pcf, about 5 pcf to about 15 pcf, about 10 pcf to about 35 pcf, about 10 pcf to about 30 pcf, about 20 pcf to about 30 pcf, about 10 pcf to about 20 pcf, about 25 pcf to about 35 pcf, or about 25 pcf to about 40 pcf (1 pcf=16.0 kg/m³). For example, the density of the foam composite may be about 3 pcf, about 4 pcf, about 5 pcf, about 8 pcf, about 10 pcf, about 11 pcf, about 12 pcf, about 13 pcf, about 14 pcf, about 15 pcf, about 16 pcf, about 17 pcf, about 18 pcf, about 19 pcf, or about 20 pcf. The density of the foam composite may be selected based on the amount and type of inorganic filler material(s) incorporate into the foam composite.

Acoustic properties of the sound control component (e.g., capacity for sound absorption) may be at least partially tuned by the amount and/or type(s) of polymer(s) and/or inorganic filler(s) of the foam composite. The composites herein provide a customization unavailable to panel systems based on pure polymers or pure inorganic materials. For example, the polymer may be selected to provide various viscoelastic properties, such as storage modulus and/or loss modulus, which may tailor sound absorption properties of the sound control component. In the case of polyurethane, for example, the amount of crosslinking and polymerization may be controlled based on the types of polyols (e.g., molecular weight, molecular structure, hydroxyl number, etc.) and isocyanate selected.

The foam composite may be porous with a tortuous structure formed by a combination of open cells and closed cells. The closed cell content may be less than or equal to 50%, such as less than or equal to 30%, e.g., between 10% and 50%, or between 20% and 40%. The cell content can be measured by ASTM D6226-15. An indication of tortuosity of the foam composite may be provided by porosimetry and mercury intrusion measurements and/or by measuring sound absorption characteristics according to ASTM E1050-10, Standard Test Method for Impedance and Absorption of Acoustical Material Using a Tube, Two Microphones and a Digital Frequency Analysis System.

The porosity, pore connectivity, and/or tortuosity of the foam composites herein may be engineered by controlling chemical and processing parameters to produce the desired sound control properties. Without intending to be bound by theory, it is believed that the cell structure of the foam composites herein may provide improved sound control properties. For example, the porous structure of the foam composite may establish a tortuous structure of open cells and closed cells that capture and attenuate sound waves, thus inhibiting transmission of sound through the foam composite. The highly tortuous channel structure combined with a relatively higher mass, e.g., provided by the inorganic filler, may provide for improved sound absorption in the lower frequency range. For example, the tortuosity of the foam composite may cause sound waves to bounce off the walls of the channels and lose energy, thereby providing sound attenuation and/or sound absorption.

In some examples herein, the foam composite may have a porosity greater than or equal to 30% and less than or equal to 95%, such as 30% to 95%, 50% to 95%, 60% to 90%, 75% to 95%, 30% to 60%, 55% to 80%, 50% to 65%, or 70% to 85%. Porosity can be measured as the ratio of void volume to total volume by comparing the bulk density (density of the foam composite) to particle density (density of the foam material), as follows:

$$\% porosity = 100 - ( \frac{bulk density}{particle density} ) \times 100 \qquad Equation 1$$

The foam composites herein may have a macro-scaled pore structure that allows for sound attenuation of higher frequency vibrations. Without intending to be bound by theory, it is believed that relatively large pores may be more effective at capturing higher sound frequencies, while relatively smaller pores may be more effective at capturing lower sound frequencies.

Cell structure can also be assessed using a pycnometer, which calculates the volume and density of a sample by feeding helium into a closed chamber with the sample inside. With the known values of sample mass, volume of the empty chamber, and mass and density of the helium, the pycnometer calculates the volume and density of the sample inside. For a porous material, closed cells of the material block helium from entering the sample and result in a larger measured volume and lower corresponding density, as compared to a sample having a higher open cell percentage. The volume of open cells may be calculated by subtracting the volume measured by the pycnometer, from the geometric volume measured manually (e.g., with calipers, ignoring surface pits or open cells):

V_{OpenCells}=V_{Geometric}−V_{Pyconometer} Equation 2

The open cell percentage may be calculated by dividing the volume of open cells by the geometric volume:

$$\% {Cell}_{o p e n} = ( \frac{{V}_{OpenCells}}{{V}_{Geometric}} ) \times 100 \% \qquad Equation 3$$

According to some aspects of the present disclosure, the foam composites may have an open cell percentage of at least 5%, such as 5% to 95%, 25% to 95%, 45% to 95%, 55% to 95%, 50% to 80%, 20% to 60%, or 65% to 85%.

The sound control component optionally may comprise a facing material or combination of facing materials disposed on one or more surfaces of the foam composite. The facing material(s) may comprise, for example, one or more elastomeric, e.g., viscoelastomeric materials, cementitious materials, fibrous materials, or combinations thereof. Exemplary facing materials include, for example, acrylics, urethane-based materials, rubber-based materials, and combinations thereof. For example, the foam composite may include at least one layer of elastomeric material(s) on one or more surfaces of the foam composite. The layer(s) may be continuous (e.g., completely covering the one or more surfaces of the foam composite), discontinuous (e.g., disposed on only a portion or certain areas of the foam composite), and/or porous (e.g., providing spaces or channels to allow the passage of sound waves therethrough).

Without intending to be bound by theory, it is believed that combining the foam composite with a layer of such material(s) may assist in attenuating sound waves having a range of frequencies. Interaction of the mechanical wave of the sound with one or more facing material(s), e.g., a viscoelastic matrix, may provide for dampening of sound. For example, the foam composite may include relatively larger, tortuous pores more effective at trapping and dissipating higher frequency sounds in the voids present in the porous foam structure, while the facing material(s) may be more effective at trapping and dissipating lower frequency sounds. In some examples, the foam composite may include relatively smaller, tortuous pores more effective at trapping and dissipating lower frequency sounds, or a combination of larger and smaller pores to trap sound within a range of lower and higher frequencies. Additional or alternative benefits of one or more layers of facing materials may include water resistance, flame retardancy, and/or low flex deflection.

According to some examples herein, the foam composite includes at least one layer of a facing material on one or more surfaces of the foam composite. The facing material may include an elastomeric material and/or a cementitious material. For example, the cementitious material may comprise cement and an aggregate, e.g., greater than or equal to 60% by weight cement and less than or equal to 30% by weight aggregate, based on the total weight of the facing layer(s). Exemplary cements include Portland cement, rapid-hardening cement, calcium aluminate cement, calcium sulfoaluminate cement, slag, other specialty type cement, a blend of cements, a blend of pozzolans, and combinations thereof. Exemplary aggregates include natural mineral perlite, expanded perlite, hollow glass beads, foamed glass beads, ground silica sandwiching, amorphous silica, diatomaceous earth, rice hull ash, blast furnace slag, granulated slag, steel slag, mineral oxides, mineral hydroxides, clays, magnasite, dolomite, layeric beads, volcanic tuff, pumice, ground tire rubber, metal oxides and hydroxides, and combinations thereof. In at least one example, the foam composite includes a layer of facing material comprising fiberglass, cement, and limestone.

The thickness of the layer(s) of facing material(s) may be less than or equal to 25 mm, such as 1 mm to 25 mm, 1 mm to 10 mm, 2 mm to 15 mm, 3 mm to 10 mm, 1 mm to 5 mm, or 5 mm to 10 mm. In some examples, the sound control component does not include facing material(s). In at least one example, the sound control component comprises a facing material comprising an acrylic, a urethane-based material, and/or a rubber-based material, and does not include cementitious materials.

The sound control component may be flexible, e.g., providing for a versatile substrate useful in panel systems with sound reducing properties. At the same time, the sound control component may have sufficient rigidity in order to serve as a substrate for additional layers or sandwich structures of an intertenancy wall. Such panel systems may be incorporated into walls, partitions, sheets, planks, and other building structures. Further, for example, the sound control components herein may provide for reduced dust and flying particles when cutting the foam composite, e.g., as compared to other materials, such as products based on glass fibers or compressed mineral wool.

Acoustic properties of the sound control component may be characterized by one or more parameters, such as the weighted sound reduction index (R_{w}), a single-number quantity that characterizes the airborne sound insulation of a material or building element over a range of frequencies, and/or the spectrum adaptation term (Ctr), a single number rating method defined in BS EN ISO 717 that uses a standard reference curve to determine the weighted value of airborne sound insulation. The sound control components herein may have a weighted reduction index with spectrum adaptation term (R_{w}+Ctr) higher than 50.

The noise reduction coefficient of a material provides an indication of how easily the material can attenuate sound transmission, wherein noise reduction corresponds to the difference from one side of the material (e.g., a panel) where the sound is emitted versus the other side of the material where the sound is detected. The noise reduction coefficient of the foam composites herein can be measured according to ASTM E1050-08, Standard Test Method for Impedance and Absorption of Acoustical Materials Using a Tube, Two Microphones and a Digital Frequency Analysis System. The foam composites herein may have a noise reduction coefficient greater than or equal to 0.5, such as greater than or equal to 0.6, greater than or equal to 0.65, greater than or equal to 0.7, or greater than or equal to 0.8, e.g., a noise reduction coefficient of 0.5 to 0.9, or 0.5 to 0.7, at frequencies of 1 kHz or higher, such as frequencies of 2 kHz or higher. A noise reduction coefficient of 0.5 or greater is indicative of a material that attenuates sound at a given frequency. In at least one example, a sound control component according to the present disclosure having a density of 5 pcf to 15 pcf, an open cell percentage of 50% to 95%, and a thickness of about 1 inch has a noise reduction coefficient of at least 0.5 at a frequency of 1 kH, and at least 0.6 or at least 0.65 at a frequency of 2 kHz. For example, the sound control component may comprise a polymer and an inorganic filler, e.g., 40% to 60% by weight, such as about 50% by weight, of the inorganic filler.

According to some aspects of the present disclosure, the sound control component may have a measured transmission loss across various frequencies. For example, the sound control component may have a transmission loss of at least 20 dB at a frequency of 2100 Hz, at least 35 dB at a frequency of 3100 Hz, and/or at least 40 dB at a frequency of 5100 Hz. Further, for example, the sound control component may have a transmission loss of at least 30 dB at a frequency of 2100 Hz, at least 40 dB at a frequency of 3100 Hz, and/or at least 45 dB at a frequency of 5100 Hz. Transmission loss characteristics can be measured according to ASTM E2611-17. Sound control characteristics may be described based on an average transmission across selected frequencies, e.g., 2, 3, 4, or 5 selected frequencies of sound.

The sound control component may have sufficient mechanical strength and durability to maintain the integrity of the wall or other barrier between two rooms or other compartments of a building structure. For example, the sound control component (and/or the foam composite of the sound control component) may have a desired compressive strength and/or flexural strength. In at least one example, the foam composite may have a compressive strength of 20 psi or greater, such as from 20 psi to 25 psi. Compressive strength can be measured by the stress measured at the point of permanent yield, zero slope, on the stress-strain curve as measured according to ASTM D695-15. Flexural strength can be measured as the load required to fracture a rectangular prism loaded in the three point bend test as described in ASTM C1185-08 (2012), wherein flexural modulus is the slope of the stress/strain curve. Crack is measured by flexural strength, which provides an indication of the resistance to abuse during installation.

The panel systems herein may include an attachment mechanism coupled to the sound control component, e.g., the attachment mechanism being configured to secure the sound control component within a building structure. Exemplary attachment mechanisms include, but are not limited to, fasteners, brackets, and rails. For example, the attachment mechanism may include one or more fasteners in the form of screws, nails, bolts, pins, rods, clips, etc., that attach the sound control component to an adjacent wall, frame, or other building structure. Additionally or alternatively, the fastener(s) may secure the sound control component to another part of the attachment mechanism, such as a bracket and/or a rail. For example, the attachment mechanism may comprise one or more brackets having a U-shaped portion that receives an edge of the sound control component, wherein the sound control component is secured to the bracket via one or more fasteners. Another portion of each bracket may be secured to a wall, frame or other building structure. According to some examples herein, the attachment mechanism may include a rail or rail system. For example, each rail may define a slot into which a corresponding sound control component may be placed, wherein multiple rails may be coupled together in order to connect adjacent sound control components to form a continuous sheet or panel. Brackets and/or fasteners may be used to further secure the sound control component to the rail or rail system.

The attachment mechanism may secure the sound control component to one or more walls. For example, the attachment mechanism may include a fastener, bracket, and/or rail system that secures the sound control component in a vertical position between two walls. Each of the walls may comprise any suitable building materials, including, but not limited to, drywall, fibrous materials (including natural and synthetic wood or materials simulating wood), concrete, stucco, brick, stone, tile, polymers (including laminates), plaster, metals and metal alloys, and combinations thereof. In at least one example, the sound control component is disposed vertically between two walls, each of which comprises drywall. In at least one example, the sound control component is disposed vertically between two walls, each of which comprises concrete or stucco.

According to some aspects of the present disclosure, the panel systems may include multiple components configured to be coupled together via a tongue and groove connection or other complementary mating features. For example, the panel system may comprise two or more sound control components each having one or more projections along a first edge of the sound control component and a recess having a shape complementary to the project along a second edge of the sound control component opposite the first edge. Thus, sound control components may be coupled together by inserting the projections of a sound control component into corresponding recesses of an adjacent sound control component. Each sound control component may have a generally planar (e.g., rectangular) shape, such that two or more connected sound control components also may form a generally planar (e.g., rectangular) structure. In some examples, fasteners such as screws, nails, bolts, pins, rods, clips, etc., may be used to further secure adjacent sound control components together.

The panel systems herein may be provided for assembly between walls on-site, e.g., the panel system comprising at least a sound control component, and optionally an attachment mechanism. That is, the panel system may be configured for installation between walls. In some cases, the size and/or shape of the sound control component and/or of the attachment mechanism may be customizable and tailored to the dimensions of the walls, which may be pre-installed in the building structure. Thus, for example, controlling sound transmission between a first wall and a second wall of the building structure may include placing the sound control component between the first wall and the second wall, and securing the sound control component between the first and second walls with an attachment mechanism. In at least one example, the sound control component may be placed within a rail system between the first and second walls. Alternatively, the sound control component first may be placed within a rail system, and then the rail system then placed between, and secured to, the first and second walls.

In some examples, the panel system may include one or more walls on either side of the sound control component, e.g., the panel system being provided as a composite structure for installation between two rooms to serve as a partitioning wall. In such cases, the sound control component and the walls may have similar dimensions.

The panel systems herein may meet applicable building regulations and codes.

### EXAMPLES

The following examples are intended to illustrate the present disclosure without being limiting in nature. It is understood that the present disclosure encompasses additional embodiments consistent with the foregoing description and following examples.

### Example 1

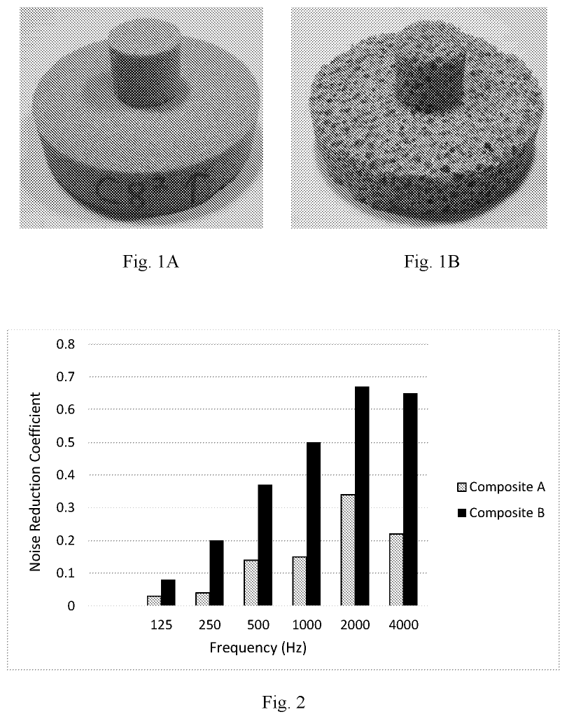

Two polyurethane foam composites (Composites A and B) were prepared according to Table 1, wherein Composite B was prepared with a greater amount of water as a blowing agent. The polyol was an aromatic polyester polyol, and fly ash was used as the filler. Composite B (see FIG. 1B) had a more porous structure than Composite A (see FIG. 1A). The composites were prepared by mixing polyol with isocyanate, surfactant, catalyst, water, and the fly ash to form a mixture, and introducing the mixture into a mold to form the foam composites.

TABLE 1

| | | Composite A | Composite B |
|---|---|---|---|
| Polyol | (g) | 89.32 | 77.90 |
| Isocyanate | (g) | 109.79 | 119.76 |
| Filler | (g) | 200.00 | 200.00 |
| Water | (g) | 0.89 | 2.34 |
| | | (1 pphp) | (3 pphp) |
| Total | (g) | 400.00 | 400.00 |

Four samples each measuring 1″×1″×1″ were cut from each composite for testing with a pycnometer (Quantachrome Upyc 1200e) to determine the average volume and open cell percentage, as discussed above. Results are reported in Table 2 as averages of the four samples, confirming that Composite B had a higher volume and open cell percentage, and a lower geometric density.

TABLE 2

| | | | | | | | | Avg | |
|---|---|---|---|---|---|---|---|---|---|
| | | Avg. | Avg | Avg | Avg | Avg | Avg | volume | Avg |
| | Avg. | volume | density | density | volume | density | density | open | open |
| | mass | (cc) | (g/cc) | (pcf) | (cc) | (g/cc) | (pcf) | cells | cell |
| Composite | (g) | Geometric | | | Pycnometer | | | (cc) | (%) |
| A | 3.28 | 16.39 | 0.200 | 12.5 | 11.7 | 0.283 | 17.7 | 4.71 | 28.8 |
| B | 1.89 | 16.39 | 0.115 | 7.19 | 2.36 | 0.794 | 49.6 | 14.0 | 85.6 |

The higher percentage of open cells in Composite B reflects greater tortuosity and connectivity of the pores, as compared to Composite A. The porous cell structure of Composite B is expected to provide for greater sound absorption capacity, e.g., due to its tortuous/connected pores.

### Example 2

Acoustic characteristics of samples of Composites A and B from Example 1 were analyzed. The Composite A sample had a density of 12.9 pcf, and the Composite B sample had a density of 7.4 pcf. Sound absorption characteristics were measured according to ASTM E1050-08 (Standard Test Method for Impedance and Absorption of Acoustical Materials Using a Tube, Two Microphones and a Digital Frequency Analysis System) at frequencies of 125 Hz, 250 Hz, 500 Hz, 1000 Hz, 2000 Hz, and 4000 Hz. Results are shown in FIG. 2, indicating that the lower density Composite B exhibited greater absorption at each frequency.

It is intended that the specification and examples be considered as exemplary only, with a true scope and spirit of the present disclosure being indicated by the following claims.

What is claimed is:

1. A panel system for controlling sound transmission between a first wall and a second wall, the panel system comprising:
a sound control component comprising:
a foam composite comprising a polymer and an inorganic filler, wherein the inorganic filler is present in an amount of 40% to 80% by weight, based on the total weight of foam composite; and
an attachment mechanism configured to secure the sound control component between the first wall and the second wall;
wherein the foam composite has a density of 3 pcf to 30 pcf; and
wherein the foam composite has (i) a porosity of 30% to 95% and/or (ii) an open cell percentage of 5% to 95%.

2. The panel system of claim 1, wherein the attachment mechanism comprises at least one of a tongue, a groove, a fastener, a bracket, or a rail.

3. The panel system of claim 1, wherein the foam composite has a thickness less than or equal to 75 mm.

4. The panel system of claim 1, wherein the sound control component further comprises a facing material covering a surface of the foam composite, the facing material comprising a viscoelastic material.

5. The panel system of claim 4, wherein a thickness of the facing material is less than or equal to 25 mm.

6. The panel system of claim 1, wherein the foam composite has a noise reduction coefficient of 0.5 or greater at frequencies of 1 kHz or higher.

7. The panel system of claim 1, wherein the foam composite further comprises a fire retardant, a fiber material, or a mixture thereof.

8. The panel system of claim 1, wherein the polymer of the foam composite comprises polyurethane.

9. The panel system of claim 1, wherein the inorganic filler comprises fly ash, limestone, clay, gypsum, or glass powder.

10. The panel system of claim 1, wherein each of the first wall and the second wall comprises drywall, a fiber, a polymer, or metal.

11. A method of controlling sound transmission between a first wall and a second wall, the method comprising:
providing a panel system comprising a sound control component between the first wall and the second wall, wherein the sound control component comprises a foam composite comprising a polymer and an inorganic filler, wherein the inorganic filler is present in an amount of 40% to 80% by weight, based on the total weight of foam composite;
wherein the foam composite has a density of 3 pcf to 30 pcf;
wherein the foam composite has (i) a porosity of 30% to 95% and/or (ii) an open cell percentage of 5% to 95%; and
wherein the sound control component attenuates transmission of sound therethrough.

12. The method of claim 11, wherein the panel system comprises an attachment mechanism comprising at least one of a tongue, groove, fastener, a bracket, or a rail, wherein the attachment mechanism secures the sound control component between the first wall and the second wall.

13. The method of claim 12, wherein the attachment mechanism comprises at least one bracket and at least one fastener.

14. The method of claim 12, wherein each of the first wall and the second wall comprises drywall, a fiber, a polymer, or metal.

15. The method of claim 11, wherein the foam composite has a noise reduction coefficient of 0.5 or greater at frequencies of 1 kHz or higher.

16. The method of claim 15, wherein the foam composite has a noise reduction coefficient of 0.65 or greater at frequencies of 2 kHz or higher.

17. A method of controlling sound transmission between a first wall and a second wall, the method comprising:
providing a panel system comprising:
a sound control component between the first wall and the second wall, wherein the sound control component comprises a foam composite comprising a polymer and an inorganic filler, wherein the inorganic filler is present in an amount of 40% to 80% by weight, based on the total weight of foam composite; and
an attachment mechanism securing the sound control component between the first wall and the second wall;
wherein the foam composite has a density of 3 pcf to 30 pcf;
wherein the foam composite has (i) a porosity of 50% to 95% and/or (ii) an open cell percentage of 5% to 95%; and
wherein the sound control component attenuates transmission of sound therethrough.

18. The method of claim 17, wherein the attachment mechanism comprises at least one fastener and at least one bracket.

19. The method of claim 17, wherein the foam composite has a noise reduction coefficient of 0.5 or greater at frequencies of 1 kHz or higher.

20. The method of claim 17, wherein the polymer of the foam composite comprises polyurethane, and the inorganic filler comprises fly ash, limestone, clay, gypsum, or glass powder.
